(19) United States
(12) Patent Application Publication
(10) Pub. No.: US 2018/0024807 A1
(43) Pub. Date: Jan. 25, 2018

(54) System and Method of Document and Signature Management

(71) Applicant: Vision Menu, Inc., Fort Wayne, IN (US)

(72) Inventors: Ron Martin, Fort Wayne, IN (US); David Smith, Fort Wayne, IN (US); Ricky Chronister, Huntertown, IN (US)

(21) Appl. No.: 15/656,636

(22) Filed: Jul. 21, 2017

Related U.S. Application Data
(60) Provisional application No. 62/364,951, filed on Jul. 21, 2016.

(51) Int. Cl. G06F 3/14; G06F 17/24; G06F 3/0484; G06F 17/21; G06K 9/00; G06F 3/0488

(52) U.S. Cl. CPC G06F 3/1454; G06K 9/00463; G06F 3/04883; G06F 3/04845; G06F 17/212; G06F 17/24; G06Q 50/18

(57) ABSTRACT

A system and method for document review and signature management that generally allows users to amend or alter a document image digitally and to sign, initial, or otherwise verify the amendments or alterations as they would a paper document, but digitally, remotely, and in real time. The system and method generally allow users to selectively open, close, scroll, shrink, expand, highlight, or otherwise manipulate a digital document image without digitally writing upon it by interacting with some document locations, while interaction with other document locations will selectively result in digital writing, all of which being reflected substantially in real time on one or more selected secondary devices also capable of interacting with the document image in a manner similar to the primary device, with any manipulation or writing inputted on a secondary device reflected substantially in real time on the primary device.

### CROSS REFERENCE TO PRIOR APPLICATIONS

This Application claims priority to and incorporates fully by reference U.S. Provisional Application No. 62/364,951, System and Method of Document and Signature Management, filed on Jul. 21, 2016.

### STATEMENT OF GOVERNMENT FUNDING

Not applicable.

### BACKGROUND

The present invention relates to the digital management, manipulation, amendment, alteration, initialing, or signature of documents, and more particularly to the utilization of handwritten signatures in connection with electronically stored document images that may or may not exist in paper form.

Handwritten signatures utilizing pen and paper have been the basis of contracts in commerce for hundreds of years. The prevalence of pen-and-paper signature has been a function the ready availability of ink pens and paper, as well the numerous advantages implicit in physical, permanent signature. Some of these advantages, as has long been recognized by the art, include: (1) that the signature and the signed document merge, bound together by the ink being on the paper; (2) the identity of the signer can be verified by a trained forensic handwriting analyst, and such analysts are generally found by courts to be qualified to offer expert testimony should a dispute over document execution arise; and (3) the signer can execute multiple copies so that all concerned parties can have an executed version of the contract, or facsimile copies of the executed document can be created for all the records of all parties.

Although pen-and-paper signatures have advantages, they also have numerous disadvantages. Specifically, pen-and-paper signature requires either the parties to physically meet for execution of the contract, or for the contract document itself to be transmitted in paper form to each party for signature. There has been an attempt in the art to incorporate digital or electronic signature methods, however, none of these methods has been able to approach the reliability, verifiability, and legality of pen-and-paper signatures. The possibility of fraud, and questions about what the executing party actually signed, are endemic to methods of digital signature known to the art. Further, methods of digital signature known to the art are poorly suited to accommodate revisions to documents made at the time of signing and make no provision for digital amendment, alteration, modification, or revision of the document. Further, methods of digital signature known to the art typically require the contracting party to utilize the same contract forms over and over again, as such methods are poorly equipped to properly locate a signature on unique, novel, or highly modified contract documents.

For example, early systems of digital signature utilized a simple image of a signature (such as a bit map) electronically affixed to a document as a picture of a signature. This approach had the disadvantage that the image of the signature is difficult to verify as being authorized by the signer. Also, an image of a signature can easily be scanned from an existing document or record and improperly inserted into a document as a forgery. Later systems included computer algorithms for verifying a signature prior to the user being able to sign an electronic document. Problems with this method include the need to enroll the signer into an electronic verification unit of the system prior to use, the potential for errors in the verification algorithm, and the inability to demonstrate the accuracy of verification of a signature to a layperson or in a court of law. Further, the signatures are typically not transportable to systems having different algorithms without loss of data precision. These systems also have the disadvantage of not being able to easily accommodate new contracts or modified or amended documents.

There is a need in the art for a digital means of considering and marking a document that has the flexibility and verifiability of pen-and-paper methods, and also has the convenience, ease of communication, and transmissibility of digital signature and electronic communication.

### SUMMARY

The present invention in its various embodiments meets this need by providing a method for document review and consideration that enables, for example, parties to a contract to use a stylus or a finger to write upon an electronic contract in the same manner that they would write upon a paper contract, with the writing (such as a signature) being affixable to any location on the document selected by a user. The present invention further provides a method for parties to amend or alter an existing document digitally and to sign, initial, or otherwise verify the amendments or alterations as they would a paper document, but digitally, remotely, and in real time. The present invention further provides a method for the immediate digital signature, amendment, or alteration of documents new to a system or documents imaged previously or at the time of execution using a scanner or camera, without requiring alteration of the document image file or additional programming relating to mapping the document. The invention further allows for a method of digital document management that allows one user to selectively open, close, scroll, shrink, expand, highlight, or otherwise manipulate a digital document without digitally writing upon it by interacting with some document locations, while interaction with other document locations will selectively result in digital writing, all of which being reflected substantially in real time on a secondary device also capable of interacting with the document in a manner similar to primary device, with any manipulation or writing inputted on the secondary device reflected substantially in real time on said primary device. The present invention further provides a system and method for contracts to be signed digitally in the same manner as a pen-and-paper contract, and then saved as signed and/or transmitted via email to the parties or to third parties, transmitted via facsimile to the parties or to third parties, or transmitted to a local or remote storage device for later review, transmission, or printing. Thus the system combines the advantages of pen-and-paper document management and signature with the efficiency of digital signature, electronic communications, and computer operations.

One aspect of the invention comprises a system that includes a primary device with an input interface, preferably a touchscreen, and a secondary device with an input interface, preferably a touchscreen. Each of the primary device and secondary device is separately electrically interfaced with a computer processor, an electronic communication means such as an Ethernet, Bluetooth, or wireless internet or direct connection, and, optionally, an electronic storage device. The primary device and secondary device are in communication, such communication being direct, such as by direct wired connection or direct Bluetooth connection; or indirect, such as through a network connection by which the primary device and secondary device connect though one or more web servers, node servers, or both. Optionally, a system may comprise a plurality of secondary devices, each with an input interface, preferably a touchscreen. Each secondary device is separately electrically interfaced with a computer processor, an electronic communication means such as an Ethernet, Bluetooth, or wireless internet or direct connection, and, optionally, an electronic storage device. The primary device and each secondary device are in communication, such communication being direct, such as by direct wired connection or direct Bluetooth connection; or indirect, such as through a network connection by which the primary device and secondary device connect though one or more web servers, node servers, or both. A secondary device may optionally comprise any personal electronic device that is commonly used in the art, such as a desktop computer, a laptop computer, a tablet computer, or a smartphone.

The system in its aspects also includes a management program. The management program may be resident in electronic storage of the primary device and/or a secondary device, or may be resident in a web server or node server accessible by the primary device and a secondary device, such as through a web-based interface. The management program may also interact with or overlay a word processing or document reader program.

In use, a document image, such as a .pdf, .tiff, .jpg, .png, or other commonly-accepted document image format, is stored in device storage or in a server database, and is displayed on the primary device and selectively also displayed on one or more of the secondary devices. The management program permits a user of the primary device to manipulate the document image to, by way of non-limiting example, open the document image, close the document image, change from one document image to another, add material to a document image, remove material from a document image, turn pages, scroll up, scroll down, shrink, expand, highlight portions, and the like. The program causes any manipulation of the document image by the primary device to be communicated to the secondary device and to be replicated substantially in real time on the document image displayed on the secondary device. As will be understood, such replication may be selective, and certain manipulations may at the direction of the primary device user or on a pre-selected basis not be communicated to a selected secondary device or replicated on the display of a selected secondary device. The management program further optionally permits a user of a secondary device to manipulate the document image displayed on the secondary device in like fashion, with such manipulations optionally communicated to the primary device and any selected additional secondary devices and replicated substantially in real time on the document image displayed by the primary device and any selected secondary device.

The management program further permits a user of the primary device to designate a writing realm, defined by reference to device coordinates, by indicating the desired location of such writing realm on the document image displayed on the primary device. Designation of a writing realm on the document image displayed by the primary device results in a corresponding writing realm being designated substantially in real time at a corresponding location on the document image displayed by the secondary device. Optionally, a visual indicator of the location of the writing realm is provided on the document image displayed by the primary device, and a corresponding visual indicator of the location of the writing realm is replicated substantially in real time on the document image displayed by the secondary device.

Once a writing realm is designated, the management program permits digital writing within the area of the writing realm using an input interface. Preferably, touching a device touchscreen within the area of the writing realm will result in the management program receiving a multiplicity of coordinates over time generated by manual movement against the touchscreen and storing those respective sets of the coordinates in sequential order as an electronic signature while preserving a time relation between coordinates, such data being displayed visually as writing. Such writing may be, and is preferably, replicated substantially in real time within the writing realm of the other device. Such digital writing may comprise a signature or initials, or may comprise alterations, amendments, strike-outs, line-outs, or additions to the document.

Thus, the present system and method can be utilized for the substantially real-time consideration, alteration, amendment, addition to, initialing, and/or signature of a contract or other document among multiple parties remote from each other, substantially in real time, in the manner of pen-and-paper writing. As will be understood by one skilled in the art, a secondary device need not be physically present with the primary device during use of the system, so long as each device is in communication with each other device. Optionally, the primary device may initiate a remote session via email invite sent to any selected secondary device.

In one aspect of the invention, the above-described system is utilized in a method for the execution of third-party contracts presented to an automobile purchaser during the course of finalizing financing during an automobile purchase. Currently, automobile dealers typically print off a menu of service, warranty, or other additional third-party offerings for potential purchase at the time financing is offered. The buyer may opt to purchase a menu option by physical signature on the printed paper menu provided by the dealer. This method presents some difficulties and costs, as copies of the physically signed paper must be carefully managed by the dealer to ensure that the dealer and the third-party provider of the purchased service each possess or have sufficient access to executed copies. Further, it takes considerable time after execution to deliver executed paper copies to the third-party provider.

The system and method of the present invention greatly speeds and improves this process by providing a method including the steps of:
(1) providing a primary user with a primary device;
(2) providing a secondary user with a secondary touchscreen device, where the primary and secondary devices each include a computer processor and are connected through communication means either directly, or through wired or Bluetooth connection, or indirectly, by means of one or more web servers or node servers;
(3) providing a management program accessible by both the primary device and the secondary device, wherein said management program:
   (a) displays a document image stored by one or more of said primary device and a server database on the screens of each of said primary device and said secondary device;
   (b) permits said primary user to open, close, scroll up, scroll down, enlarge, shrink, highlight, or otherwise manipulate said document image on said primary device by inputting commands using the primary device input interface, which is preferably a touchscreen;
   (c) communicates any manipulation of said document image by said primary user to the secondary device, where said manipulation is selectively displayed on the document image on the screen of the secondary device substantially in real time;
   (d) permits said primary user to designate a writing realm on the document image by touching a point on the document image displayed on the screen of the primary device adjacent to the location desired to constitute said writing realm;
   (e) indicates the location of the writing realm on the screen of the primary device with a visual indicator;
   (f) communicates the location of the writing realm to the secondary device and, substantially in real time, designates a writing realm on the secondary device that corresponds to the location of the writing realm on the primary device and also displays a visual indicator on the secondary device that corresponds to the location of the visual indicator on said primary device;
   (g) captures any input on the secondary device, preferably a touch input on a secondary device touchscreen, within the writing realm as writing;
   (h) displays that writing within the writing realms on the screens of each of the secondary device and the primary device, substantially in real time; and
   (i) saves a processed document image including said writing as part of the image.

### DRAWINGS

These and other features, aspects, and advantages of the present invention will become better understood with reference to the following description and accompanying drawings, where:

FIG. 1 is a pictorial block diagram of an electronic signature management system according to the present invention;

FIG. 2 is a flow chart of a computer process for document signature capture using the system of FIG. 1;

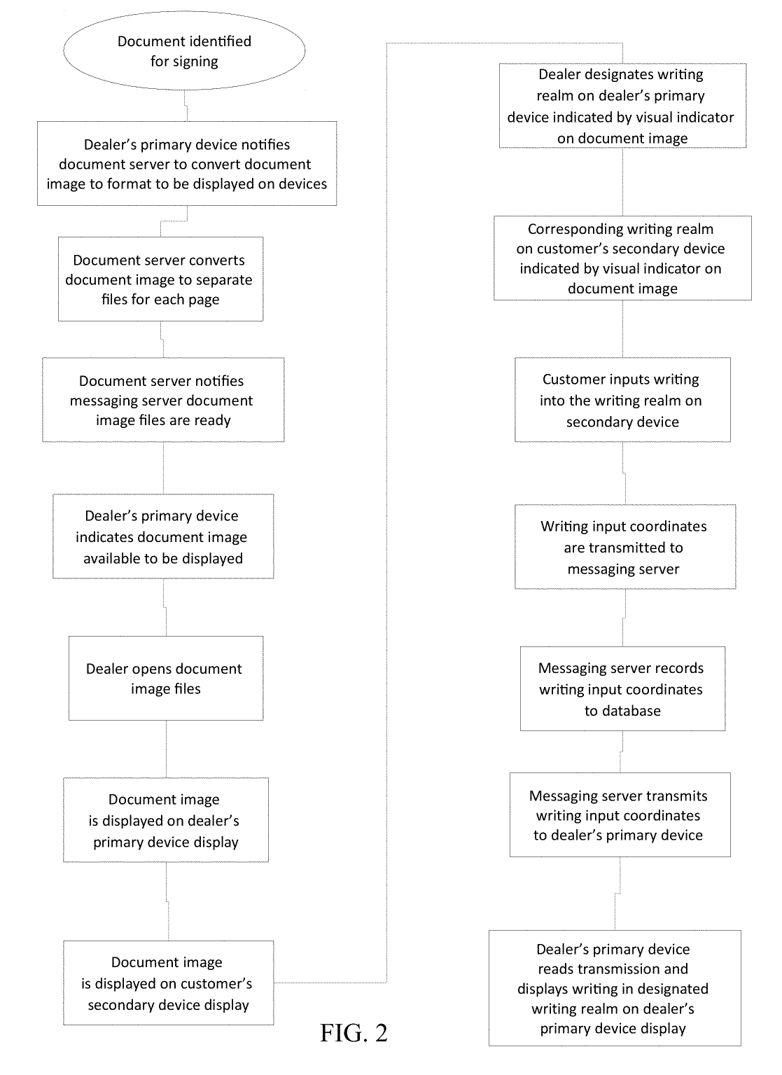

FIG. 3 is a flow chart of a computer process for binding, storing, and retrieving a document having an electronic signature using the system of FIG. 1;

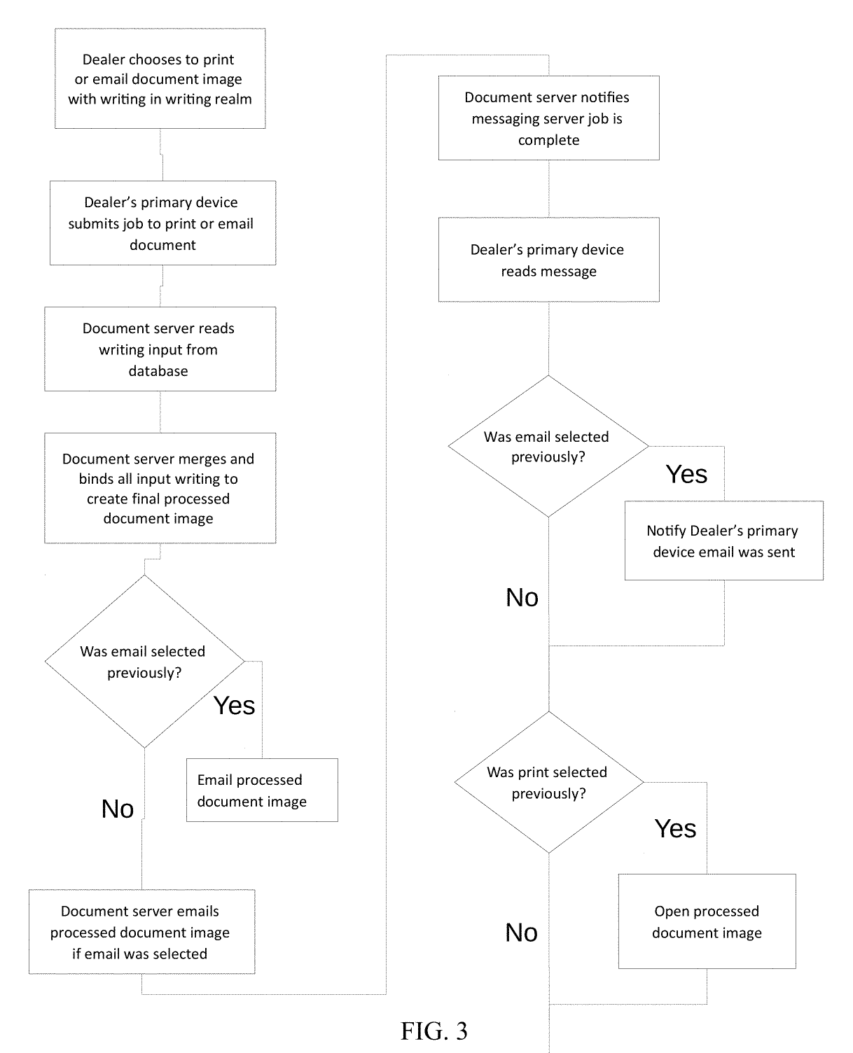

FIG. 4 is a screen display of a primary device displaying a document image according to the present invention;

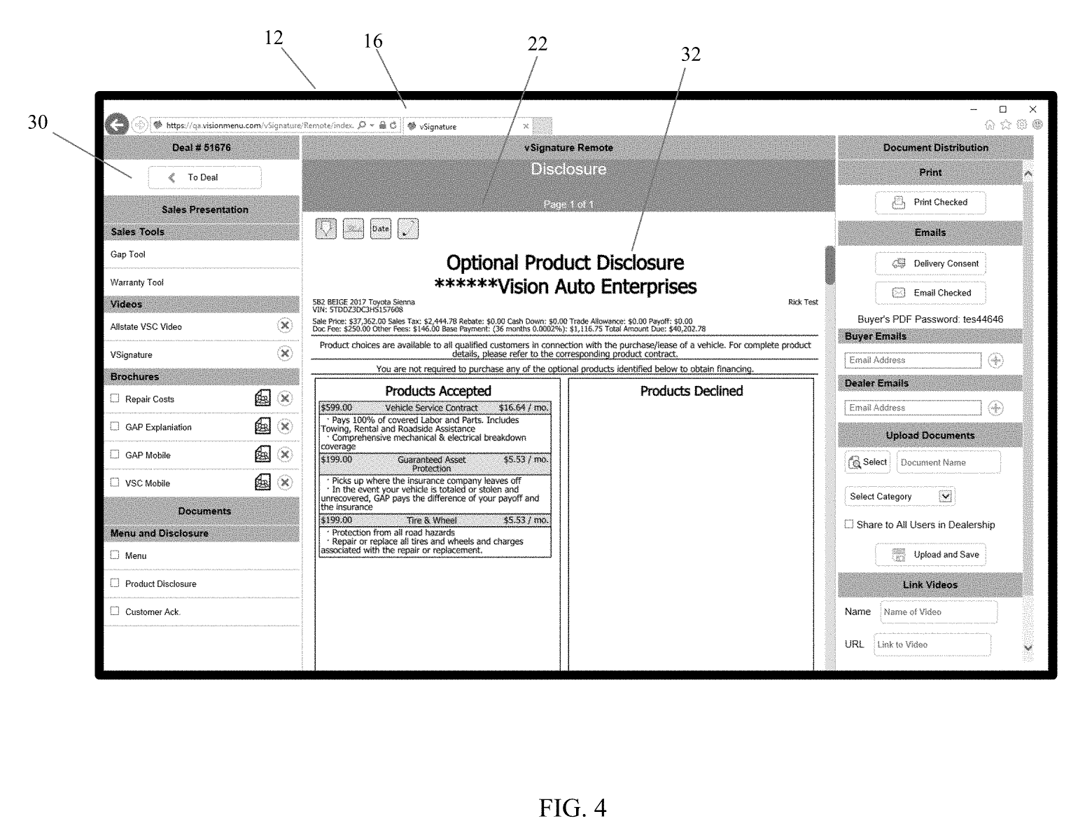

FIG. 5 is a screen display of a secondary device displaying a document image corresponding to the document image of FIG. 4;

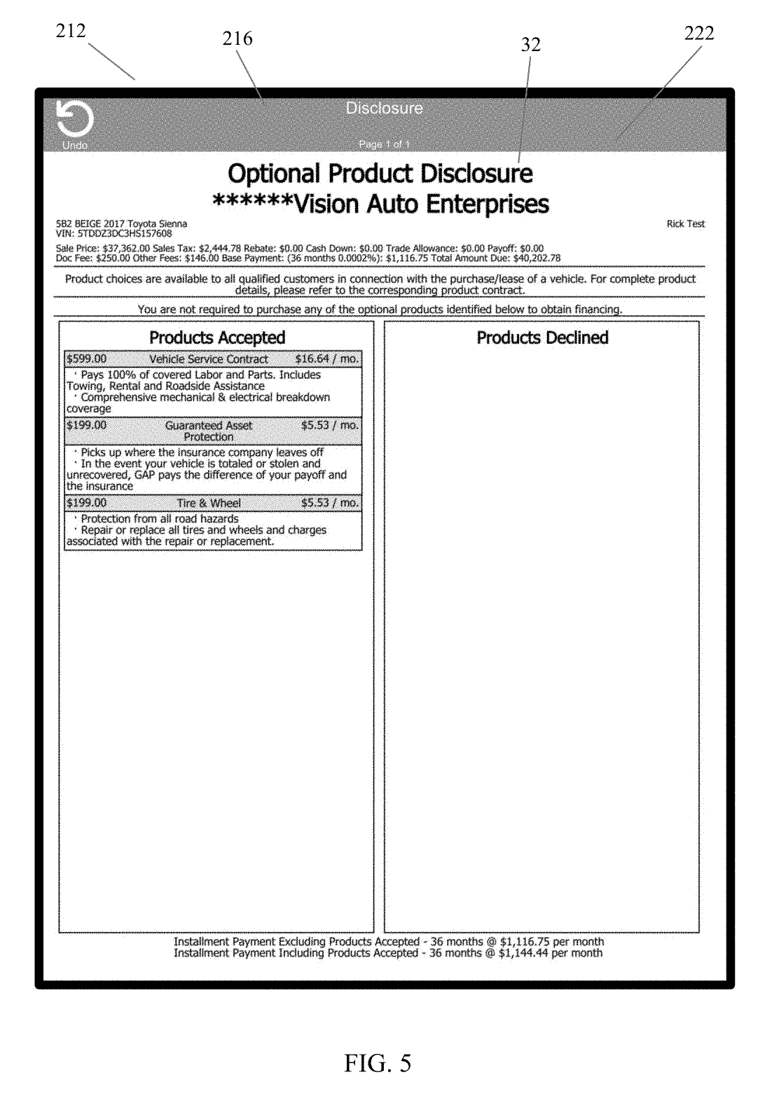

FIG. 6 is a screen display of a primary device displaying a document image with a designated writing realm and a visual indicator according to the present invention;

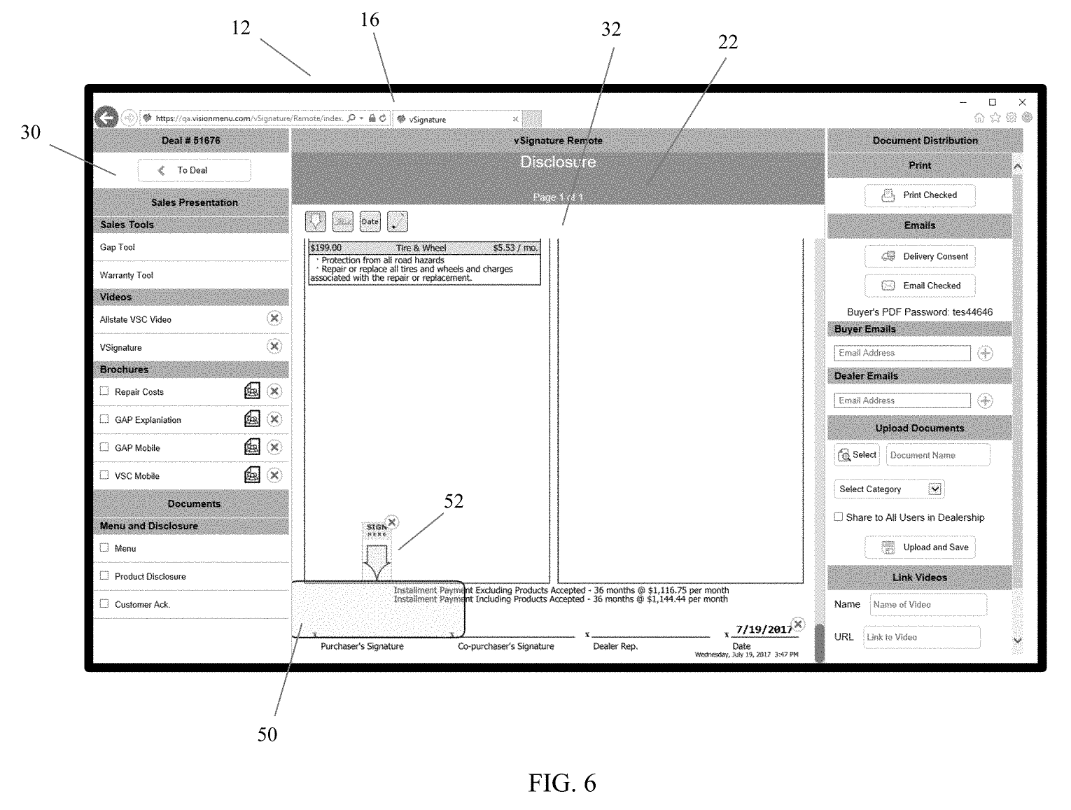

FIG. 7 is a screen display of a secondary device displaying a document image with a designated writing realm and a visual indicator corresponding to the designated writing realm and visual indicator of FIG. 6;

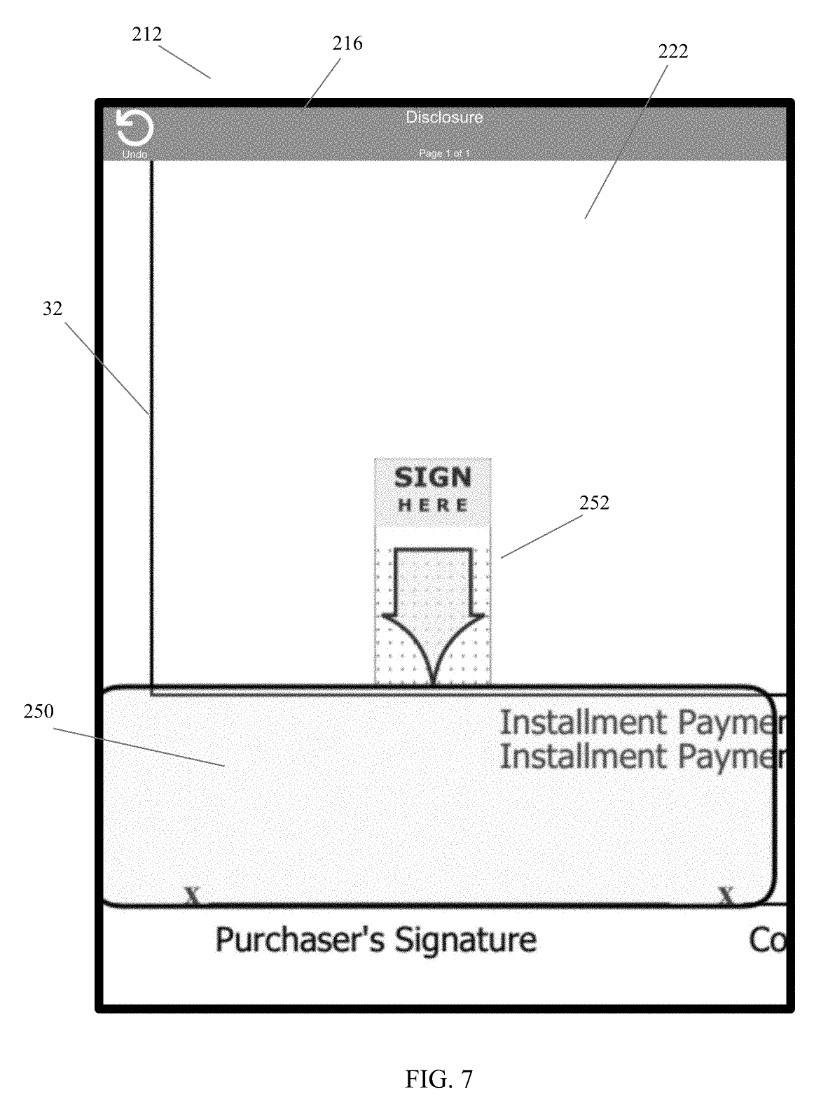

FIG. 8 is a screen display of a secondary device displaying a document image with writing inside a designated writing realm according to the present invention;

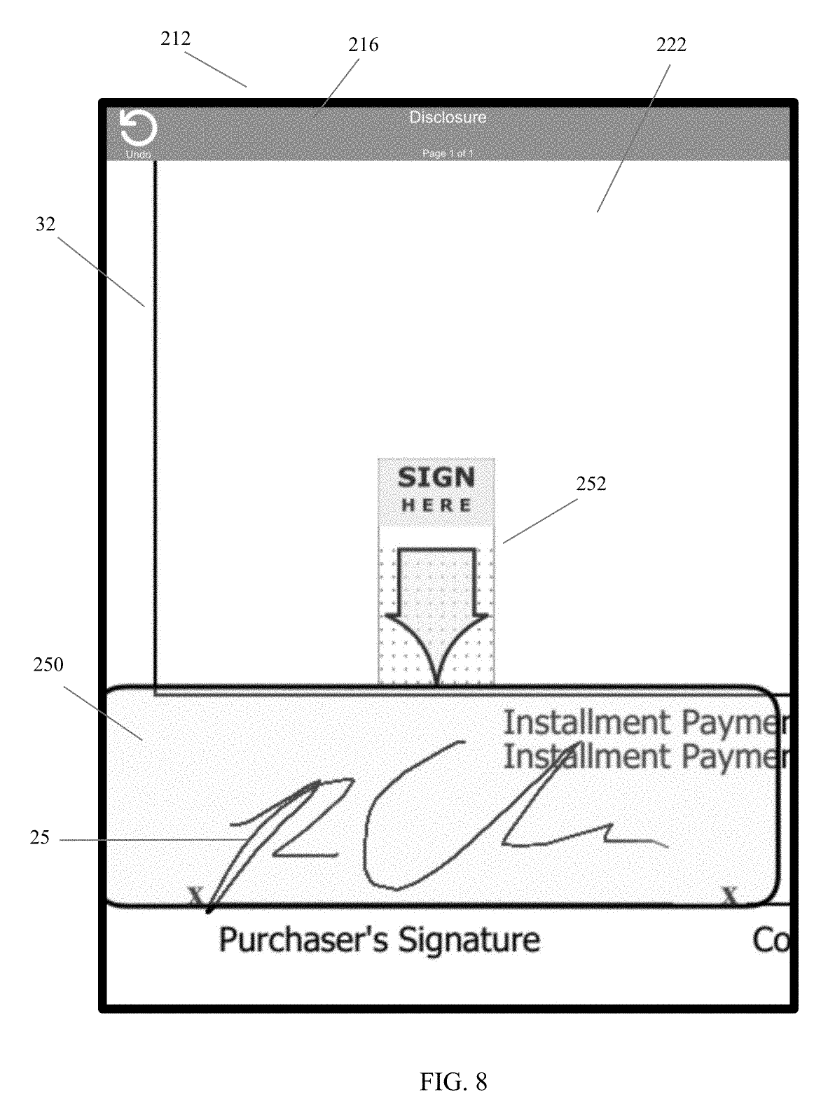

FIG. 9 is a screen display of a primary device displaying a document image with writing inside a designated writing realm corresponding to the writing of FIG. 8; and

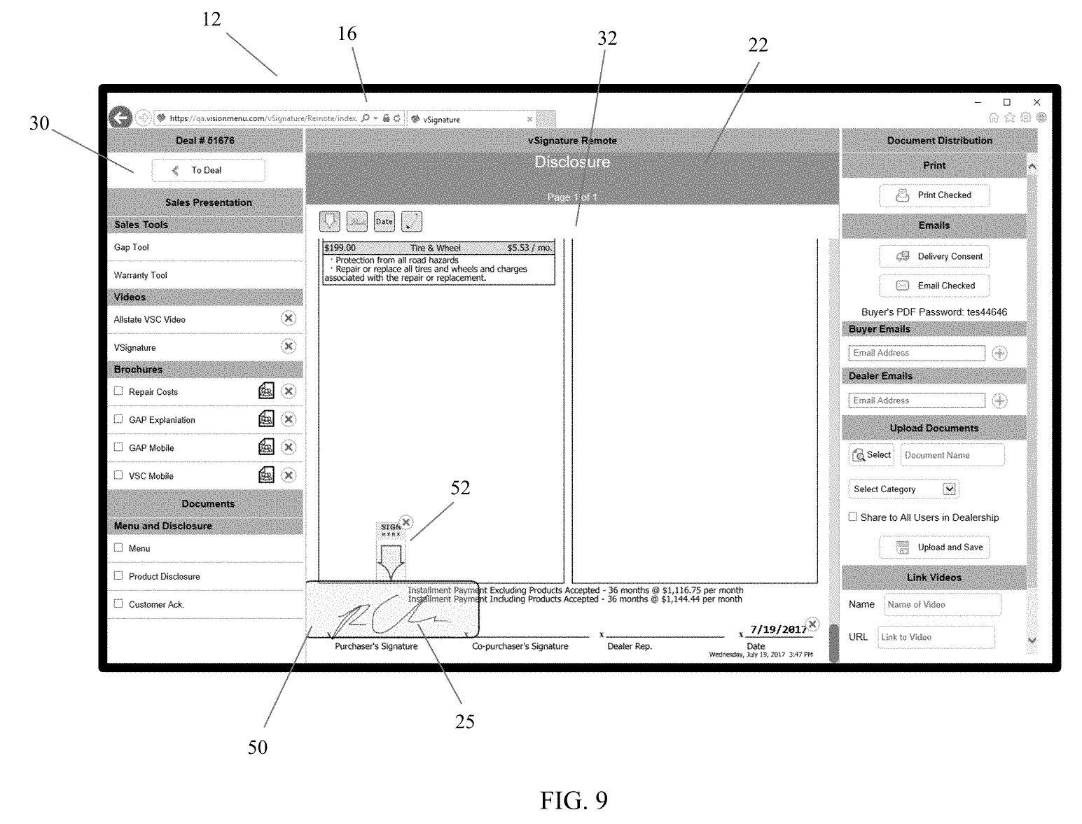

FIG. 10 is a screen display of a processed document image according to the present invention.

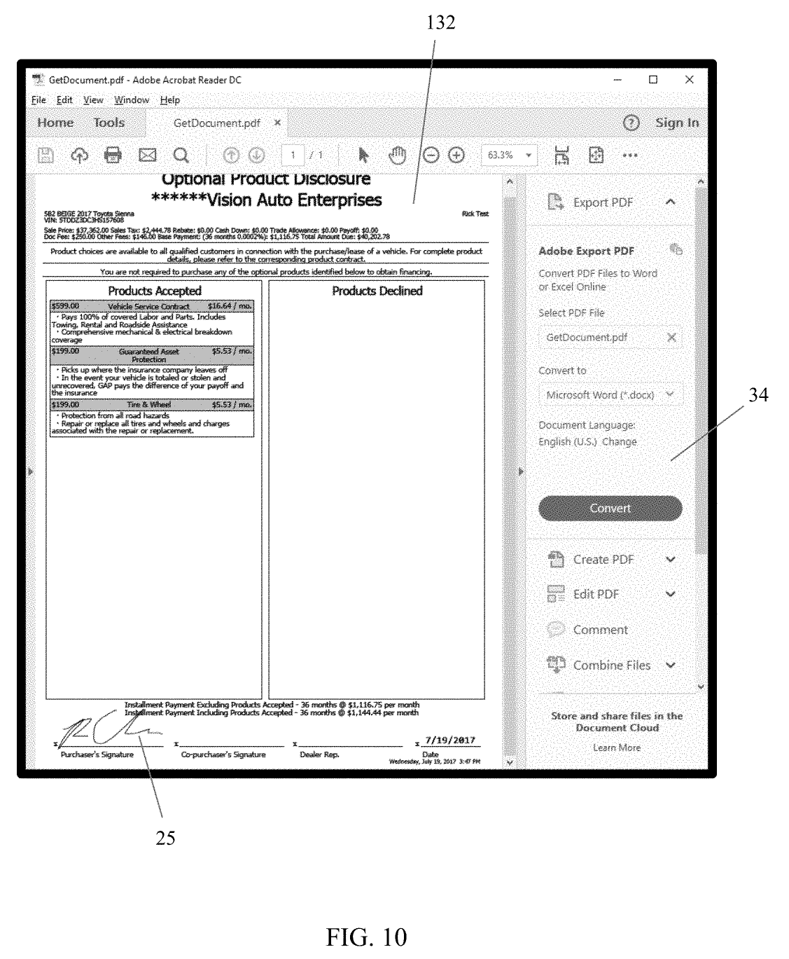

### DESCRIPTION

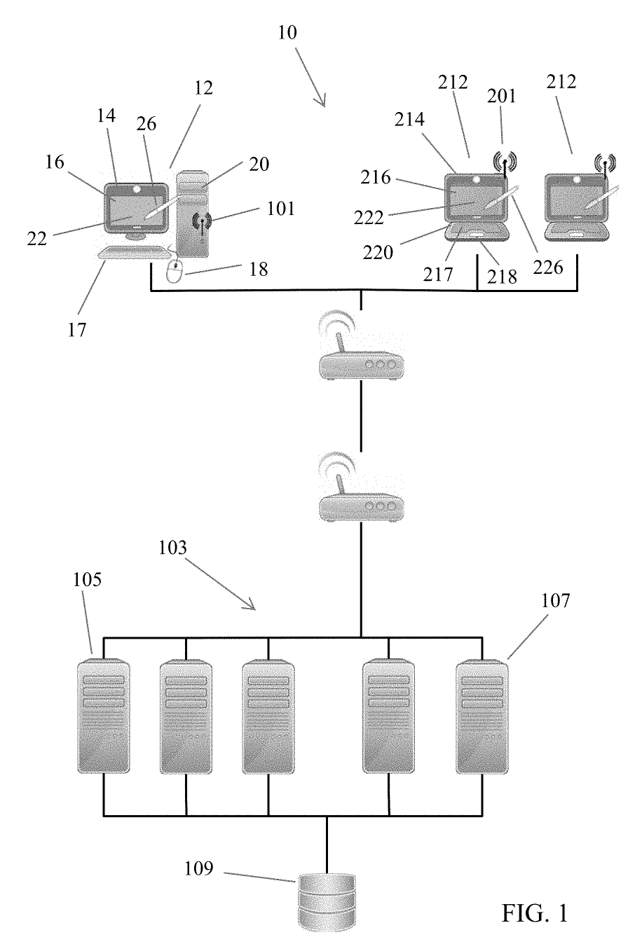

The present invention is directed to a computer-based system and method of document and signature management that is effective, reliable, resistant to forgery, and that permits verification of digital writing and signatures by traditional handwriting analysis methods while enabling the convenience of digital input and electronic communication. With reference to FIG. 1 of the drawings, a system 10 according to embodiments of the present invention includes a primary device 12 having an operator interface 14 including at least a screen display 16, and a communication means 101 such as a Bluetooth transmitter and receiver, Ethernet port, wireless network transmitter and receiver, or the like. The primary device 12 optionally includes an input interface 22 for capturing writing 25. Such input interface 22 may comprise a pen tablet using a stylus 26, or may optionally comprise a touch-sensitive screen display 16, commonly known as a touchscreen, and the user's finger or a stylus 26. Optionally, the primary device 12 also includes a keyboard 17 and a pointing device or mouse 18. The primary device may 12 also include memory 20, typically including volatile random access memory (RAM) and non-volatile memory such as read-only memory (ROM) and random access disk memory. As used herein, storage in non-volatile memory can include temporary storage in volatile memory.

Embodiments of the system 10 of the present invention further comprise a secondary device 212 having an operator interface 214 including at least a screen display 216, and a communication means 201 such as a Bluetooth transmitter and receiver, Ethernet port, wireless network transmitter and receiver, or the like. Further embodiments of the system 10 may optionally comprise a plurality of secondary devices 212, each having an operator interface 214 including at least a screen display 216, and a communication means 201 such as a Bluetooth transmitter and receiver, Ethernet port, wireless network transmitter and receiver, or the like. A secondary device 212 further includes an input interface 222 for capturing writing 25. Such input interface 222 may comprise a pen tablet using a stylus 226, or may optionally comprise a touch-sensitive screen display 216, commonly known as a touchscreen, and the user's finger or a stylus 226. Optionally, a secondary device 212 also includes a keyboard 217 and a pointing device or mouse 218. The secondary device may 212 also include memory 220, typically including volatile random access memory (RAM) and non-volatile memory such as read-only memory (ROM) and random access disk memory.

According to the present invention, the input interface 222 is implemented for transmitting position coordinates such as x-, y-, and z-axis data to the secondary device 212, the coordinate data representing precise intervals in the progression of the writing 25 from its inception to completion. Such writing 25 is transmitted substantially in real time as a dynamic capture file or other similar file via the communications means 201 to a server 103 such as a web server 105 or node server 107, and from the server 103 to the primary device 12 via communication means 101, all substantially in real time. Optionally, said writing 25 may be transmitted directly from said secondary device 212 via communication means 201 to said primary device 12 via communication means 101. As will be understood by one skilled in the art, a secondary device 212 need not be physically present with the primary device 12 during use of the system 10, so long as each device is in communication with each other device. Optionally, the primary device 12 may initiate a remote session via an email invitation sent to any selected secondary device 212. Writing 25 may optionally be stored by the secondary device 212 as a dynamic capture file or other similar file in the memory 220.

Optionally, a primary device input interface 22 is implemented for transmitting position coordinates such as x-, y-, and z-axis data to the primary device 12, the coordinate data representing precise intervals in the progression of the writing 25 from its inception to completion. Such writing 25 is transmitted substantially in real time as a dynamic capture file or other similar file to a server 103 such as a web server 105 or node server 107, or, optionally, directly to a secondary device 212. The writing 25 may optionally be stored by the primary device 12 as a dynamic capture file or other similar file in the memory 20.

In further accordance with embodiments of the present invention, the primary device 12 and secondary device 212 are provided with a document and signature management program, 30, such management program 30 being stored in memory 20, 220 or stored on a server 103 and accessed by communications means 101, 201. The primary device 12 and secondary device 212 are also implemented and configured for electronic storage and retrieval of a document image 32 in any suitable manner, such as by having an installed word processor or image file reader, such as a .pdf, .tiff, .jpg, or other image file reader, which can be a conventional commercially available programs. All of the above, and their analogs, will be referred to as “word processors” 34 herein. It will be understood that the management program 30 can be operated as a macro of a word processor 34; the word processor 34 can be invoked under the control of the management program 30; and/or the word processor 34 can be combined with the management program 30 as a unified program, as desired, using conventional programming devices. Herein, reference to the operation and function of the management program 30 will be understood to include operation and function of the management program 30 in relation to or in connection with a word processor 34. Also, as used herein, the document images 32 are electronically stored images of documents. The substantive content of the document images 32 can define an entire electronic document, a collection of document data indexed in a database, a few characters and data representing a sales transaction, and many other possible forms to be authenticated or approved by signatures as described herein. Document images 32 as used herein may refer to .pdf, .jpg, .tiff, .png, .bmp, .jpeg, or any other recognized image format.

The management program 30 in one aspect controls the process of manipulating and digitally writing upon a document image 32 by the primary device 12 and/or secondary device 212, as described herein. First, a selected document image 32 is generated by means known to the art, such as creating a .pdf, .tiff, or other image file of an existing digital or physical document, or taking a photograph or other digital image of a physical document. The document image 32 is stored, temporarily or permanently, on a server database 109, and optionally in memory 20 or memory 220. The document image 32 is presented for display on the primary device 12 and/or secondary device 212 in an image format.

In conjunction with the word processor 34, general manipulation of the document image 32 by the primary device 12, preferably using the input interface 22, although optionally using a keyboard 17 or mouse 18, will result in opening, closing, scrolling, shrinking, expanding, highlighting, adding materials to the document, removing materials from the document, or other common manipulations of the document image 32 as would be understood by one skilled in the art. Any manipulation of the document image 32 by the user of the primary device 12 is conveyed by instruction of the management program 30 to the secondary device 212 through the communication means 101, 201, preferably via an intermediate server 103, and such manipulation is replicated on the document image 32 displayed by the secondary device 212 substantially in real time. Optionally, general manipulation of the document image 32 by the secondary device 212, preferably through the input interface 222, although optionally through a keyboard 217 or mouse 218, will result in opening, closing, scrolling, shrinking, expanding, highlighting adding materials to the document, removing materials from the document, or other common image file manipulations as would be understood by one skilled in the art. Any such manipulation of the document image 32 by the user of the secondary device 212 is conveyed by instruction of the management program 30 to the primary device 12 through the communication means 101, 201, preferably via an intermediate server 103, and such manipulation is replicated on the document image 32 displayed by the primary device 12 substantially in real time.

It will be understood that the communication of such manipulation from the primary device 12 to a secondary device 212, or vice-versa, may be selective, so that none, some, or all such manipulations may be communicated. It will further be understood that the document image shown by the primary device 12 may have portions or fields not shown on the document image on the display of the secondary device 212, and vice-versa.

The management program 30 further provides a means for a user of the primary device 12 to designate a writing realm 50 on said document image 32. A writing realm 50 is a range of device coordinates defining an area of selected shape and size on the screen of said primary device 50. The user of said primary device 12 may designate a writing realm 50 by touching or otherwise inputting (such as using a mouse pointer) the location desired for writing on the document image 32 displayed on the primary device screen. The writing realm 50 will then be designated as a set of device coordinates of the primary device 12 related to the selected point. As will be understood, a writing realm 50 can be of any shape or size. Preferably, a writing realm 50 is pre-set by the management program 30 as a rectangle with a coordinate range large enough to contain a normally-sized signature in reference to the document image 32. The management program 30 may provide that the writing realm 50 be any of several pre-selected shapes or sizes selected by a user, or may provide that the writing realm 50 may be a custom shape or size selected or inputted by a user.

The writing realm 50, as will be understood, will be designated by the management program 30 in pre-set relation to the point on the document image 32 selected by the user. By way of example, the management program 30 may be adapted to designate the writing realm 50 as centered on the selected point. Alternatively, the management program 30 may be adapted to designate the writing realm 50 as having its top edge, bottom edge, or a left or right edge centered on the selected point. Still alternatively, the management program 30 may be adapted to designate the writing realm 50 as having one corner defined by the selected point, or in virtually any other relation to the selected point. Preferably, a visual indicator 52 appears on the primary device 12 screen to indicate the location of the selected point, and thus indicate the general location of the writing realm 50 on the document image 32. Since a user will typically understand the pre-set relation between the location of the selected point and the selected writing realm 50, a visual indicator 52 of the selected point will enable the user to know where any writing 25 should be inputted in relation to the visual indicator 52. Preferably, the visual indicator 52 includes a visual indication, such as by way of example an arrow, of the location of the writing realm 50.

The management program 30 instructs utilization of the communication means 101, 201 to transmit data associated with the writing realm 50 to the secondary device 212. With respect to the secondary device 212, the management program 30 instructs the secondary device to designate a writing realm 250 at device coordinates on the secondary device 212 that correspond to the device coordinates of the writing realm 50 of the primary device 12. The secondary device writing realm 250 functions in all other respects in like fashion as the primary device writing realm 50. Preferably, a visual indicator 252 appears on the secondary device 212 screen to indicate the location of the writing realm 250 on the document image 32.

On the secondary device 212, manipulation of the document image 32 by the secondary device 212 within the writing realm 250, preferably by the input interface 222, although optionally by a keyboard 217 or mouse 218 will result in the management program 30 receiving a multiplicity of coordinates over time generated by manual movement against the input interface 222, and storing those respective sets of the coordinates in sequential order as digital writing 25 while preserving a time relation between coordinates. When such inputs are applied to the secondary device within the writing realm 250, the management programming provides that the coordinates of the writing 25 are replicated substantially in real time within the writing realm 50 of the primary device 12. Optionally, such digital writing 25 within the secondary device writing realm 250 may be replicated substantially in real time on the primary device 12 within the primary device writing realm 50. Such digital writing 25 may comprise a signature, or may comprise alterations, amendments, line-outs, additions, or any other writing upon the document.

Writing 25 within the writing realm 50 or writing realm 250 is, as will be understood, overlaid on the document image 32 by operation of the management program 30. If a user attempts to interact with the document image 32 at an image location outside of the writing realm 50 or writing realm 250, such as by use of the input interface 22 or input interface 222, such interaction will not result in writing 25, but will result in document image 32 manipulation as described above. Optionally, document image 32 manipulation may be selectively locked out when a writing realm 50 is designated.

As will be understood, multiple writing realms 50 may be designated on a single document image 32, simultaneously or in sequence. Further, a writing realm 50 may be designated at the discretion of the user at any location on the document image 32. Because the primary device writing realm 50 is defined by reference to device coordinates, and the secondary device writing realm 250 is defined by reference to the coordinates of the secondary device 212 that correspond to the designated coordinates on the primary device 12, and not by reference to document coordinates, no additional or supplementary programming or instructions specific to the document image 32 is needed for the management program 30 to locate the primary device writing realm 50 and the secondary device writing realm 250 at the desired location on the document image 32.

After writing 25 is applied by either the primary device 12 or secondary device 212 within the writing realm 50, 250 of the document image 32, the management program may instruct the document image 32 to be saved as a processed document image 132 on primary device storage 20, secondary device storage 220, or in a server database 109. The saved processed image document 132 will include any writing 25 overlaid over the original document image 32. In this fashion, a document image 132 processed by the present system and method is similar to a document written upon using pen and paper.

It will be understood that the communication of writing within a writing realm 50, 250 from the primary device 12 to the secondary device 212, or vice-versa, may be selective, so that none, some, or all such writing may be communicated.

As will be understood by one skilled in the art, the primary device 12 and secondary device 212 may be in the same room or may be remote from each other. Further, the primary device 12 and secondary device 212 may be connected by a wired connection or Bluetooth connection, or may be indirectly connected via a server 103 such as a web server 105 or node server 107. Such indirect connection may be facilitated by a web-based interface by which each device accesses a server 103 on which the management program 30 is stored.

In a preferred embodiment of the invention, the above-described system is utilized within a method for the execution of contracts presented to an automobile purchaser during the course of finalizing financing during an automobile purchase. This preferred method includes the steps of:
(1) providing a primary user with a touchscreen primary device 12;
(2) providing a secondary user with a touchscreen secondary device 212, where the primary and secondary touchscreen devices each include a computer processor and are each connected to the other through communication means 101, 201 either directly, through wired or Bluetooth connection, or indirectly, by means of one or more web servers or node servers;
(3) providing a management program 30 accessible by both the primary device 12 and the secondary device 212, wherein said management program 30:
   (a) displays a document image 32 stored by at least one of said primary device 12 or a server 103 on the screens of each of said primary device 12 and said secondary device 212;
   (b) permits said primary user to open, close, scroll up, scroll down, enlarge, shrink, highlight, or otherwise manipulate said document image on said primary device by inputting commands using the primary device touchscreen;
   (c) communicates any manipulation of said document image 32 by said primary user to said secondary device 212 and replicates said manipulation of the document image 32 displayed by said secondary device 212 substantially in real time;
   (d) permits said primary user to designate a writing realm 50 by touching a point on the document image 32 adjacent to the location desired to constitute said writing realm 50;
   (e) indicates the location of the writing realm 50 on the screen of said primary device 12 with a visual indicator;
   (f) transmits the location of said writing realm 50 to said secondary device 212 and, substantially in real time, creates a writing realm 250 on said secondary device 212 at a location on the document image 32 that corresponds to the location of said writing realm 50 on the document image 32 displayed on said primary device 12, and also creates a visual indicator on the document image 32 displayed on said secondary device 212 that corresponds to the location on the document image 32 of said visual indicator displayed on said primary device 12;
   (g) records any touch input on the secondary device 212 within said writing realm 250 as writing 25;
   (h) displays said writing 25 within the writing realm 250 on the screens of each of the secondary device 212 and the primary device 12, substantially in real time; and
   (i) saves a processed document image 32 including said writing 25 as part of the image.

The forgoing disclosure is illustrative of the present invention and is not to be construed as limiting thereof Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description illustrates the present invention and is not to be construed as limited to the specific embodiments disclosed.

What is claimed is:

1. A method of document and signature management comprising the steps of:
a. providing a primary user with a primary device;
b. providing one or more secondary users with one or more secondary devices, wherein said primary device and said one or more secondary devices each include a computer processor, an operator interface, a screen display, an input interface, and a communication means, and wherein said primary device and said one or more secondary devices are each connected to the other through said communication means; and
c. providing a management program accessible by both said primary device and said one or more secondary devices, wherein said management program:
i. selectively displays a selected document image on said screen displays of said primary device and said one or more secondary devices;
ii. permits a manipulation by said primary user of said document image on said primary device by inputting commands using said input interface of said primary device;
iii. selectively communicates said manipulation of said document image by said primary user to said one or more secondary devices and selectively replicates said manipulation of said document image displayed by said one or more secondary devices substantially in real time;
iv. permits said primary user to designate a writing realm by selecting a point on said document image adjacent to a location desired to constitute said writing realm;
v. selectively transmits said location of said writing realm to said one or more secondary devices and, substantially in real time, selectively displays a writing realm on said one or more secondary devices at a location on said document image displayed on said one or more secondary devices that corresponds to said location of said writing realm on said document image displayed on said primary device;
vi. records as a writing an input within said writing realm on said one or more secondary devices;
vii. selectively displays said writing on said screen displays of said primary device and said one or more secondary devices, substantially in real time; and
viii. saves a processed document image including said writing as part of said processed document image.

2. The method of claim 1, wherein said screen displays of said primary device and said one or more secondary devices are touch-sensitive and configured for use with at least one of a finger and a stylus.

3. The method of claim 2, wherein each of said primary device and said one or more secondary devices comprises one of a desktop computer, a laptop computer, a tablet computer, and a smartphone.

4. The method of claim 3, wherein each of said primary device and said one or more secondary devices further comprises one or more of a keyboard, a pointing device, and a computer mouse.

5. The method of claim 1, wherein each of said primary device and said one or more secondary devices further comprises memory configured for permanent or temporary storage of said document images.

6. The method of claim 5, further comprising the step of selectively storing said writing in said memory of at least one of said primary device and said one or more secondary devices.

7. The method of claim 6, further comprising the step of selectively storing said processed document image in at least one of said primary device memory, said memory of said one or more secondary devices, and a server database.

8. The method of claim 1, further comprising the step of initiating remote access by said one or more secondary devices to said management program by transmitting an electronic invitation message from said primary device to said one or more secondary devices.

9. The method of claim 1, further comprising the step of providing a word processor program to each of said primary device and said one or more secondary devices, wherein said word processor program is controllable by said management program.

10. The method of claim 1, wherein said manipulation of said document image comprises one or more of opening, closing, scrolling, shrinking, expanding, highlighting, adding materials to said document image, and removing materials from said document image.

11. The method of claim 1, wherein said writing comprises a signature and wherein said writing realms comprise a rectangular shape sized to encompass said writing within said writing realms.

12. A system for document and signature management comprising:
a. a primary device comprising an operator interface, a screen display, and a primary device communication means;
b. one or more secondary devices, each comprising an operator interface, a screen display, a secondary device communication means, and an input interface for capturing a writing, wherein said input interface is configured for transmitting coordinate data, said coordinate data representing precise intervals in a progression of said writing from its inception to completion, wherein said writing is transmitted substantially in real time by said secondary device communication means to a server, and is further transmitted from said server to said primary device utilizing said primary device communication means, all substantially in real time; and
c. a management program accessible by both said primary device and said one or more secondary devices, wherein said management program:
i. selectively displays a selected document image on screen displays of said primary device and said one or more secondary devices;
ii. permits a manipulation by a primary user of said document image on said primary device by inputting commands using said input interface of said primary device;
iii. selectively communicates said manipulation of said document image by said primary user to said one or more secondary devices and selectively replicates said manipulation of said document image displayed by said one or more secondary devices substantially in real time;
iv. permits said primary user to designate a writing realm;
v. indicates said location of said writing realm on said screen display of said primary device with a visual indicator;
vi. selectively transmits said location of said writing realm to said one or more secondary devices and, substantially in real time, selectively displays said writing realm on said one or more secondary devices at a location on said document image displayed on said one or more secondary devices that corresponds to said location of said writing realm on said document image displayed on said primary device, and also indicates said location of said writing realm on said screen display of said secondary device with a visual indicator;
vii. records as writing an input on said one or more secondary devices within said writing realm;
viii. selectively displays said writing within said writing realm on said screen displays of said primary device and said one or more secondary devices, substantially in real time; and
ix. saves a processed document image including said writing as part of said processed document image.

13. The system of claim 12, further comprising a word processor program accessible to each of said primary device and said one or more secondary devices, wherein said word processor program is controllable by said management program.

14. The system of claim 13, wherein said primary device further comprises an input interface for capturing writing.

15. The system of claim 14, wherein said screen displays of said primary device and said one or more secondary devices are touch-sensitive and configured for use with at least one of a finger and a stylus.

16. The system of claim 15, wherein each of said primary device and said one or more secondary devices comprises one of a desktop computer, a laptop computer, a tablet computer, and a smartphone.

17. The system of claim 16, wherein each of said primary device and said one or more secondary devices further comprises one or more of a keyboard, a pointing device, and a computer mouse.

18. The system of claim 13, wherein each of said primary device and said one or more secondary devices further comprise memory configured for permanent or temporary storage of said document images.

19. The system of claim 18, wherein said processed document image is stored in at least one of said primary device memory, said memory of said one or more secondary devices, and a server database.

20. The system of claim 13, wherein said writing comprises a signature and wherein said writing realms designated on said document images displayed on said primary device and selectively displayed on said one or more secondary devices comprise a rectangular shape sized to encompass said writing within said writing realms.
